(19) United States
(12) Patent Application Publication
(10) Pub. No.: US 2015/0193358 A1
(43) Pub. Date: Jul. 9, 2015

(54) Prioritized Memory Reads

(71) Applicant: NVIDIA Corporation, Santa Clara, CA (US)

(72) Inventors: James M. Van Dyke, Austin, TX (US); Robert Ohannessian, JR., Austin, TX (US)

(73) Assignee: NVIDIA Corporation, Santa Clara, CA (US)

(21) Appl. No.: 14/148,277

(22) Filed: Jan. 6, 2014

(51) Int. Cl. G06F 13/16; G06F 13/18; G06F 12/08

(52) U.S. Cl. CPC G06F 13/161; G06F 12/0875; G06F 13/18; G06F 12/0871; G06F 2212/604; G06F 2212/452

(57) ABSTRACT

A system includes a processing unit and a memory system coupled to the processing unit. The processing unit is configured to mark a memory access in the series of instructions as a priority memory access as a consequence of the memory access having a dependent instruction following less than a threshold distance after the memory access in the series of instructions. The processing unit is configured to send the marked memory access to the memory system.

### TECHNICAL FIELD

This disclosure relates generally to electronics and more particularly to processing units and memory systems.

### BACKGROUND

A memory management unit is a circuit configured to handle accesses to memory requested by a processing unit, e.g., a central processing unit (CPU). A memory management unit can be configured, by hardware or software or both, to perform various functions, including cache control, memory protection, bus arbitration, and address translation. A memory management unit can operate in conjunction with a memory controller that interacts directly with a memory structure. A memory management unit and a memory controller can be configured to reduce latency, e.g., by queuing access requests and using cache allocation techniques.

### SUMMARY

In general, one aspect of the subject matter described in this specification can be embodied in a system that comprises: a processing unit; and a memory system coupled to the processing unit; wherein the processing unit is configured to: mark a memory access in the series of instructions as a priority memory access as a consequence of the memory access having a dependent instruction following less than a threshold distance after the memory access in the series of instructions; and send the marked memory access to the memory system. A system of one or more processing units can be configured to perform particular actions by virtue of having software, firmware, hardware, or a combination of them installed on the system that in operation causes or cause the system to perform the actions.

These and other embodiments can each optionally include one or more of the following features. The memory system is configured to receive the marked memory access and, in response, perform the marked memory access before at least one other memory access that is unmarked and arrived at the memory system before the marked memory access. The processing unit is configured to determine a priority rating for the memory access based on a distance between the memory access and the dependent instruction in the series of instructions or an estimate of a load level of the processing unit or both and to mark the memory access with the priority rating. The memory system is configured to reorder a number of memory accesses in a stream of accesses so that the prioritized memory access is performed before at least one other memory access that is unmarked and arrived at the memory system before the marked memory access. The memory system is configured to swap out a first stream of accesses for a second stream of accesses including the prioritized memory access. The first stream of accesses are from a different processing unit. The memory system comprises a cache, and wherein the memory system is configured to perform cache allocation based on the marked memory access. The cache allocation specifies that the marked memory access is allocated to the cache because it is marked. The memory structure is configured to exit a currently executing stream of accesses to service a different stream of accesses having the marked memory access because the marked memory access is marked. The threshold distance is based on one or more of: a number of instructions between the memory access and the dependent instruction, execution time of instructions between the memory access and the dependent instruction, or a type of one or more instructions between the memory access and the dependent instruction.

In general, another aspect of the subject matter described in this specification can be embodied in methods that include the actions of: compiling source code into a series of instructions for a first processing unit; analyzing the series of instructions, including finding a memory access followed by a dependent instruction less than a threshold distance from the memory access in the series of instructions; and editing the series of instructions so that, when the first processing unit executes the instructions, the first processing unit marks the memory access as a prioritized memory access before sending the memory access to a memory system. Other embodiments of this aspect include corresponding systems, apparatus, and computer programs, configured to perform the actions of the methods, encoded on computer storage devices. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

These and other embodiments can each optionally include one or more of the following features. Compiling the source code comprises arranging at least a first independent instruction between the memory access and the dependent instruction in the series of instructions, the first independent instruction not depending on the memory access. Editing the series of instructions comprises determining a priority rating for the memory access based on a distance between the memory access and the dependent instruction in the series of instructions or an estimate of a load level of the processing unit or both and inserting an instruction for the processing unit to mark the memory access with the priority rating. A non-transitory computer readable medium storing instructions that, when executed by one or more processing units, causes the one or more processing units to perform operations comprising: compiling source code into a series of instructions for a first processing unit; analyzing the series of instructions, including finding a memory access followed by a dependent instruction less than a threshold distance from the memory access in the series of instructions; and editing the series of instructions so that, when the first processing unit executes the instructions, the first processing unit marks the memory access as a prioritized memory access before sending the memory access to a memory system. Compiling the source code comprises arranging at least a first independent instruction between the memory access and the dependent instruction in the series of instructions, the first independent instruction not depending on the memory access. Editing the series of instructions comprises determining a priority rating for the memory access based on a distance between the memory access and the dependent instruction in the series of instructions or an estimate of a load level of the processing unit or both and inserting an instruction for the processing unit to mark the memory access with the priority rating.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a block diagram of an example processing system including a processing unit, a memory system, and a compiler.

FIG. 2 shows a table illustrating an example series of instructions.

FIG. 3 is a block diagram of the architecture of an example graphics processing unit (GPU).

FIG. 4 is a flow diagram of an example process performed by a processing unit.

### DETAILED DESCRIPTION

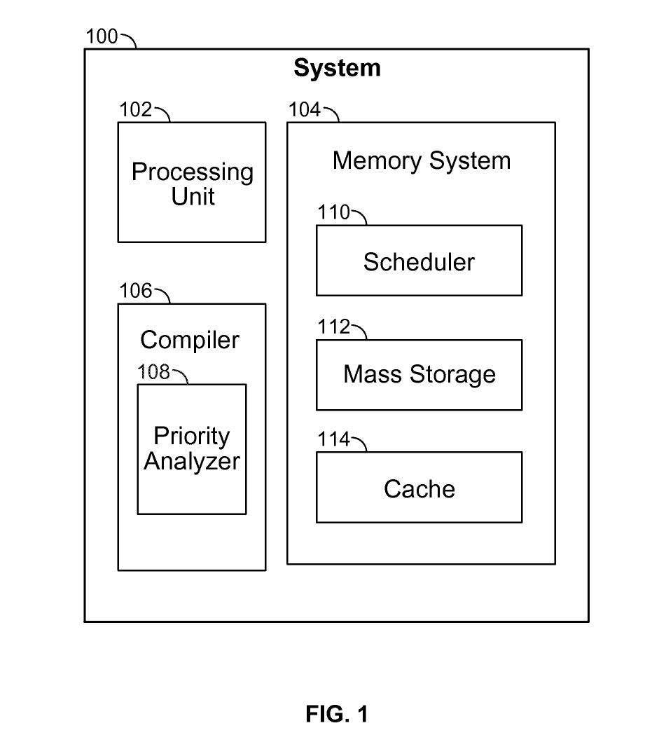

FIG. 1 is a block diagram of an example processing system 100 including a processing unit 102, a memory system 104, and a compiler 106. The compiler is configured to compile source code into a series of instructions executable by the processing unit.

The compiler can be implemented in digital electronic circuitry, or in computer software, firmware, or hardware, including the structures disclosed in this specification and their structural equivalents, or in combinations of one or more of them. For example, the compiler can be implemented as one or more computer programs, i.e., one or more modules of computer program instructions, encoded on a computer storage medium for execution by the processing unit or by some other processing unit. The source code can be, e.g., written in any of various computer programming languages, and the source code can specify one or more of various computing tasks, e.g., a computer graphics processing task, or a parallel processing task. The series of instructions can be, e.g., assembly level instructions, or object code.

The processing unit is a device that carries out the instructions of a program by performing operations, e.g., arithmetic, logical, and input and output operations. The processing unit can be, e.g., a central processing unit (CPU) of a computing system, or one of many processors in a graphics processing unit (GPU). Some processing units include an arithmetic logic unit (ALU) and a control unit (CU).

The memory system is configured to store digital data, e.g., instructions for execution by the processing unit. Devices suitable for storing program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

Memory systems can have various topologies including, e.g., various physical memory structures and control units to handle memory access requests from the processing unit. For purposes of illustration, the memory system of FIG. 1 is shown as having a scheduler 110, a mass storage structure 112 (e.g., dynamic random access memory), and a cache 114 (e.g., a level two cache). In some implementations, the scheduler and the mass storage structure and the cache are all implemented on the same chip; in some other implementations, one or more of the components can be implemented on different chips or different systems. The system can use other appropriate memory systems.

The scheduler is configured to determine a priority order for memory access requests from the processing unit. For example, the scheduler can allocate certain values between the cache and the mass storage, or batch certain requests to access the mass storage to reduce latency. The scheduler can be implemented in digital electronic circuitry, or in computer software, firmware, or hardware, including the structures disclosed in this specification and their structural equivalents, or in combinations of one or more of them.

In some implementations, the scheduler implements a cache allocation scheme to determine whether to store values in the mass storage or the cache. In some implementations, the scheduler implements a time-stamping scheme, so that the memory system time stamps memory access requests and handles memory access requests using the time stamps. For example, the memory system can service requests with older time stamps before requests with newer time stamps, or service streams of individual requests using the average time stamp of the requests in each stream.

Referring back to the compiler 106, the series of instructions produced by the compiler typically includes memory access requests and instructions that are dependent on those memory access requests. An instruction is dependent on a memory access request if the processing unit cannot execute the instruction before the memory system completes the request. An instruction is independent of a memory access request if the processing unit can complete execution of the instruction before the memory system handles the request.

The compiler can be configured to arrange instructions in the series of instructions so that independent instructions are scheduled between memory accesses and subsequent instructions that are dependent on those accesses. Arranging the instructions this way can reduce stalling of the processing unit that results from the dependency on a memory access with latency, e.g., when there is a cache miss at the memory system and the memory system has to access the mass storage. In some implementations, even though the compiler is configured to arrange independent instructions this way, the series of instructions could still include a memory access followed by a dependent instruction that will cause the processing unit to stall while waiting on the memory access.

The compiler may include a priority analyzer 108 that is configured to analyze a series of instructions and identify priority memory accesses. A priority memory access is a memory access that could potentially cause a stall of the processing unit while the processing unit waits for the memory system to service the memory access. For example, after the complier completes an initial compiled series of instructions, the priority analyzer can analyze the initial compiled series of instructions and then edit the instructions using the identified priority memory accesses, creating a subsequent series of instructions.

The priority analyzer can identify a priority memory access as a memory access having a dependent instruction following less than a threshold distance after the memory access in the series of instructions. The threshold distance can be, e.g., a number of instructions. The threshold distance can be specified by a system designer or dynamically determined by the compiler, and the threshold distance can be based on, e.g., the average latency of the memory system or the speed of the processing unit or both. The threshold can be based on a number of instructions between the memory access and the dependent instruction, based on execution time of instructions between the memory access and the dependent instruction, or based on type of instructions, e.g., the average execution time of each type of instruction between the memory access and the dependent instruction.

The compiler edits the instructions so that, when the processing unit executes the instructions, the processing unit marks the identified memory accesses as priority memory accesses before sending the memory accesses to the memory system. In some implementations, the compiler edits the instructions to insert an instruction before the memory access that, when executed by the processing unit, causes the processing unit to prioritize that memory access.

The memory system can take one or more of various appropriate actions in response to receiving a memory access that has been marked as a priority memory access. For example, the memory system can reorder a number of memory accesses in a stream of accesses so that a priority memory access is performed before some other memory accesses that arrived before the priority memory access. In another example, the memory system can swap out an earlier-received series of queued memory accesses to execute a later-received series of queued memory accesses because the later-received series contains one or more priority memory accesses. The earlier-received series and the later-received series can be from different processing units.

In another example, the memory system can perform cache allocation based on whether or not memory accesses are marked as priority memory accesses. For example, the memory system can determine to use the cache for a memory access because the memory access is marked as a priority memory access. In another example, the memory system can change a cache eviction policy based on whether or not memory accesses are marked as priority memory accesses. For example, the policy can be changed so that a prioritized memory access's cache lines are evicted at a lower priority than other cache lines. In another example, the memory system can delay a memory DRAM refresh in response to receiving a marked read memory access.

In another example, the memory system can perform a read/write turn in response to receiving a marked memory access. For example, suppose that the memory system is currently accessing a series of write accesses, and then receives a marked read memory access. The memory system can discontinue the series of write accesses and perform the marked read memory access. In some implementations, to avoid frequently changing between read and write accesses, the memory system can perform a read/write turn by turning from a series of writes to reads after a number of marked read memory accesses above a threshold accumulate.

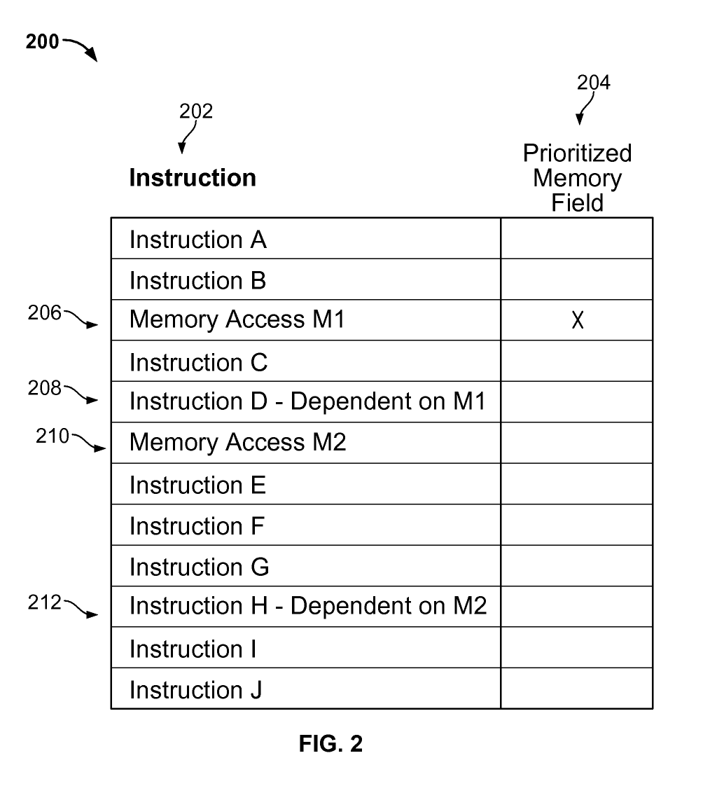

FIG. 2 shows a table 200 illustrating an example series of instructions. Each row in the table lists an example instruction. A first column 202 shows the instructions and a second column 204 shows prioritized memory field that indicates whether or not a compiler (e.g., the compiler 106 of FIG. 1) or other system or module has marked a memory access instruction as a priority memory access. For purposes of illustration, suppose that the compiler marks any memory access with a dependent instruction that is three instructions or fewer after the memory access in the series of instructions as a priority memory access.

A first memory access 206, memory access M1, has a dependent instruction 208, instruction D, that follows only two instructions after the memory access. Although the compiler has arranged one independent instruction between the memory access and the dependent instruction, there is still a possibility that the processing unit executing the instructions will stall while the memory access completes. So the compiler marks that memory access as a priority memory access. A memory system, in response to receiving the priority memory access request, can attempt to expedite the memory access to reduce the stall time. In some implementations, the system can assign a priority value to the memory access based on, e.g., the distance between the memory access and its first dependent instruction, or an estimate of how loaded a processing unit is, or both.

A second memory access 210, memory access M2, has a dependent instruction 212, instruction H, that follows four instructions after the memory access. Since the distance between the dependent instruction and the memory access is more than the example threshold, three, the compiler does not mark the second memory access as a priority memory access.

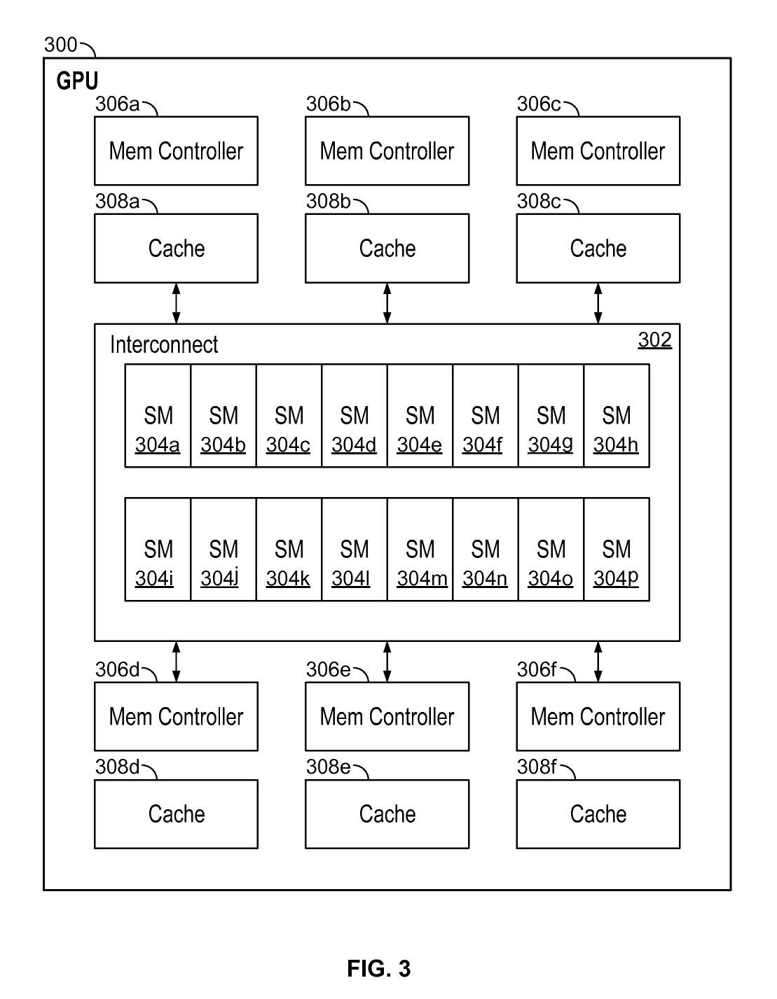

FIG. 3 is a block diagram of the architecture of an example graphics processing unit (GPU) 300. Although a GPU is shown, the architecture can be used for various processing tasks in addition to graphics processing tasks by virtue of having software, firmware, hardware, or a combination of them installed on the system that in operation causes or cause the system to perform the processing tasks.

The GPU includes an interconnect 302 and 16 processing units 304a-p which can be streaming multiprocessors (“SM”). The GPU includes six memory channels, and each channel includes a cache 308a-f, e.g., a level-2 (“L2”) cache, and a memory controller 306a-f configured to perform memory accesses, e.g., to a dynamic random access memory (DRAM) chip.

The processors are configured to perform parallel processing by executing a number of threads. The threads can be organized into execution groups called warps, which can execute together using a common physical program counter. Each thread can have its own logical program counter, and the hardware can support control-flow divergence of threads within a warp. In some implementations, all threads within a warp execute along a common control-flow path.

The processors of the GPU can be configured to mark memory accesses as priority memory accesses, e.g., as described above with reference to FIG. 1 and FIG. 2. Individual threads or warps can mark memory accesses as priority memory accesses. As a result, the GPU can reduce an amount of stalling of the streaming multiprocessors that results from executing instructions that are dependent on memory accesses that the memory channels have not yet completed.

The memory channels can respond in various appropriate ways to receiving memory access requests from the processors that are marked as priority memory accesses. For example, a memory channel can perform a first stream of access requests from one thread or warp before a second stream of access requests from a different thread or warp because the first stream includes one or more priority memory accesses. As another example, a memory channel can use a cache for a first stream of access requests and use DRAM for a second stream of access requests because the first stream includes one or more priority memory accesses.

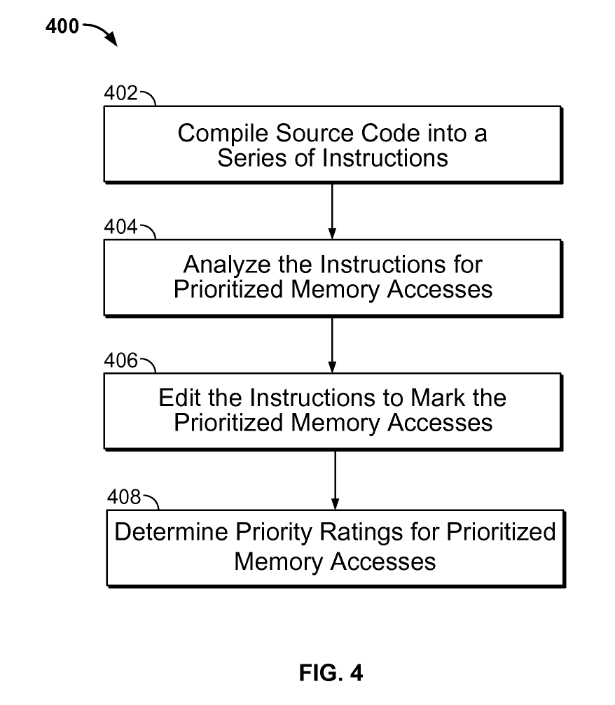

FIG. 4 is a flow diagram of an example process 400 performed by a processing unit. The processing unit can be, e.g., the processing unit 102 of FIG. 1, or a different processing unit.

The processing unit compiles source code into a series of instructions for a first processing unit (402). The source code can be, e.g., written in any of various computer programming languages. The series of instructions can be, e.g., assembly level instructions, or object code. The first processing unit can be the same processing unit that compiles the source code or a different processing unit. In some implementations, compiling the source code includes arranging independent instructions between memory accesses and instructions dependent on those memory accesses.

The processing unit analyzes the series of instructions (404). The processing unit finds at least one memory access followed by a dependent instruction less than a threshold distance from the memory access in the series of instructions. The processing unit can identify all such memory accesses in the series of instructions, or spend a certain amount of time or a certain number of clock or processor cycles identifying memory accesses that are closely followed by dependent instructions.

The processing unit edits the series of instructions so that, when the first processing unit executes the instructions, the first processing unit marks the at least one memory access and any other memory accesses identified from the analysis as a prioritized memory access before sending the memory access to a memory system (406). In some implementations, editing the series of instructions includes determining a priority rating for the memory access and inserting an instruction for the processing unit to mark the memory access with the priority rating (408). The priority rating can be based on a distance between the memory access and the dependent instruction in the series of instructions or an estimate of a load level of the processing unit or both.

In some implementations, the architecture and/or functionality of the various previous figures may be implemented in the context of a CPU, graphics processor, or a chipset (i.e. a group of integrated circuits designed to work and sold as a unit for performing related functions, etc.), and/or any other integrated circuit for that matter. Additionally, in some implementations, the architecture and/or functionality of the various previous figures may be implemented on a system on chip or other integrated solution.

Still yet, the architecture and/or functionality of the various previous figures may be implemented in the context of a general computer system, a circuit board system, a game console system dedicated for entertainment purposes, an application-specific system, a mobile system, and/or any other desired system, for that matter. Just by way of example, the system may include a desktop computer, lap-top computer, hand-held computer, mobile phone, personal digital assistant (PDA), peripheral (e.g. printer, etc.), any component of a computer, and/or any other type of logic. The architecture and/or functionality of the various previous figures and description may also be implemented in the form of a chip layout design, such as a semiconductor intellectual property (“IP”) core. Such an IP core may take any suitable form, including synthesizable RTL, Verilog, or VHDL, netlists, analog/digital logic files, GDS files, mask files, or a combination of one or more forms.

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A system comprising:
a processing unit; and
a memory system coupled to the processing unit;
wherein the processing unit is configured to:
mark a memory access in a series of instructions as a priority memory access as a consequence of the memory access having a dependent instruction following less than a threshold distance after the memory access in the series of instructions; and
send the marked memory access to the memory system.

2. The system of claim 1, wherein the memory system is configured to receive the marked memory access and, in response, perform the marked memory access before at least one other memory access that is unmarked and arrived at the memory system before the marked memory access.

3. The system of claim 1, wherein the processing unit is configured to determine a priority rating for the memory access based on a distance between the memory access and the dependent instruction in the series of instructions or an estimate of a load level of the processing unit or both and to mark the memory access with the priority rating.

4. The system of claim 1, wherein the memory system is configured to reorder a number of memory accesses in a stream of accesses so that the prioritized memory access is performed before at least one other memory access that is unmarked and arrived at the memory system before the marked memory access.

5. The system of claim 1, wherein the memory system is configured to swap out a first stream of accesses for a second stream of accesses that includes the prioritized memory access.

6. The system of claim 5, wherein the first stream of accesses are from a second processing unit.

7. The system of claim 5, wherein the first stream of accesses are from a first thread and the second stream of accesses are from a second thread.

8. The system of claim 1, wherein the memory system comprises a cache, and wherein the memory system is configured to perform cache allocation based on the marked memory access.

9. The system of claim 8, wherein the cache allocation specifies that the marked memory access is allocated to the cache because it is marked.

10. The system of claim 8, wherein the cache allocation specifies that a stream of accesses is allocated to the cache because the stream of accesses include the marked memory access.

11. The system of claim 1, wherein the memory system is configured to exit a currently executing stream of accesses to service a different stream of accesses having the marked memory access because the marked memory access is marked.

12. The system of claim 1, further comprising a compiling processing unit configured to:
process source code into the series of instructions for the processing unit;
find, within the series of instructions, the memory access; and
edit the series of instructions so that, when the processing unit executes the instructions, the processing unit marks the memory access as a prioritized memory access.

13. The system of claim 12, wherein the compiling processing unit is configured to process the source code by arranging at least a first independent instruction between the memory access and the dependent instruction in the series of instructions, the first independent instruction not depending on the memory access.

14. The system of claim 12, wherein the compiling processing unit is configured to determine a priority rating for the memory access based on one or both of the following: a distance between the memory access and the dependent instruction in the series of instructions or an estimate of a load level of the processing unit.

15. The system of claim 1, wherein the threshold distance is based on one or more of: a number of instructions between the memory access and the dependent instruction, execution time of instructions between the memory access and the dependent instruction, or a type of one or more instructions between the memory access and the dependent instruction.

16. A method performed by one or more processing units, the method comprising:
processing source code into a series of instructions for a first processing unit;
finding, within the series of instructions, a memory access followed by a dependent instruction less than a threshold distance from the memory access in the series of instructions; and
editing the series of instructions so that, when the first processing unit executes the instructions, the first processing unit marks the memory access as a prioritized memory access before sending the memory access to a memory system.

17. The method of claim 16, wherein processing the source code comprises arranging at least a first independent instruction between the memory access and the dependent instruction in the series of instructions, the first independent instruction not depending on the memory access.

18. The method of claim 16, wherein editing the series of instructions comprises:
determining a priority rating for the memory access based on one or both of the following: a distance between the memory access and the dependent instruction in the series of instructions or an estimate of a load level of the first processing unit; and
inserting an instruction for the first processing unit to mark the memory access with the priority rating.

19. A non-transitory computer readable medium storing instructions that, when executed by one or more processing units, causes the one or more processing units to perform operations comprising:
processing source code into a series of instructions for a first processing unit;
finding, within the series of instructions, a memory access followed by a dependent instruction less than a threshold distance from the memory access in the series of instructions; and
editing the series of instructions so that, when the first processing unit executes the instructions, the first processing unit marks the memory access as a prioritized memory access before sending the memory access to a memory system.

20. The computer readable medium of claim 18, wherein editing the series of instructions comprises:
determining a priority rating for the memory access based on one or both of the following: a distance between the memory access and the dependent instruction in the series of instructions or an estimate of a load level of the first processing unit; and
inserting an instruction for the first processing unit to mark the memory access with the priority rating.
